(19) United States
(12) Patent Application Publication
(10) Pub. No.: US 2024/0096539 A1
(43) Pub. Date: Mar. 21, 2024

(54) HEADER COMPONENT, INDUCTIVE DEVICE AND METHOD FOR ASSEMBLING AN INDUCTIVE DEVICE

(71) Applicant: Wurth Electronics Midcom Inc., Watertown, SD (US)

(72) Inventors: Martin ROMERO, München (DE); Tommy HUANG, Zhuhai (CN); Cem SOM, Zorneding (DE)

(21) Appl. No.: 18/461,193

(22) Filed: Sep. 5, 2023

(30) Foreign Application Priority Data
Sep. 6, 2022 (CN) 202211082851.6

(51) Int. Cl. H01F 27/02; H01F 17/04; H01F 27/29

(52) U.S. Cl. CPC H01F 27/02; H01F 17/04; H01F 27/292

(57) ABSTRACT

A header component for mounting an inductive component on a substrate comprises a housing for housing the inductive component inside a cavity, wherein the housing confines the cavity to a bottom side and to at least three lateral sides, and wherein the housing comprises a top opening to the cavity at a top side opposite to the bottom side, wherein the top opening is configured for inserting the inductive component into the cavity via the top opening. The header component further comprises a plurality of terminals for electrically connecting the inductive component to the substrate, wherein the terminals outwardly protrude from the housing at the bottom side. Further disclosed are an inductive device and a method for assembling an inductive device.

### CROSS-REFERENCE TO RELATED APPLICATIONS

The present application claims priority of Chinese patent application CN 2022 1108 2851.6, the content of which is incorporated herein by reference.

### SUMMARY

The invention concerns a header component for mounting an inductive component, in particular a transformer, on a substrate, in particular on a printed circuit board. The invention further concerns an inductive device comprising a header component and an inductive component. The invention further concerns a method for assembling an inductive device.

Headers or pin headers are known from the prior art. They are used as electrical connectors for connecting electronic components to a substrate, in particular to a printed circuit board. For that purpose, a header comprises pins or terminals for establishing an electrical connection to the substrate, in particular to conductor patterns of the substrate. U.S. Pat. No. 9,646,755 B2 discloses a header for a transformer, wherein a transformer is placed inside a housing of the header. The header is introduced into the housing via a lateral side opening.

It is an object of the present invention to improve a header component for mounting an inductive component on a substrate, in particular to provide a header component which allows for simple and automation-friendly assembly of the inductive component.

This object is achieved by a header component with the features of claim 1. The header component comprises a housing for housing an inductive component inside a cavity, wherein the housing confines the cavity to a bottom side and to at least three lateral sides and wherein the housing comprises a top opening to the cavity at a top side opposite to the bottom side, wherein the top opening is configured so that the inductive component can be inserted into the cavity via the top opening. The header component further comprises a plurality of terminals for electrically connecting the inductive component to the substrate, wherein the terminals outwardly protrude from the housing at the bottom side. The inventive header component provides the top opening at an opposite side to the terminals. Thus, an inductive component can be easily placed inside the cavity of the housing from the top, in particular it can be vertically placed by conventional pick-and-place techniques. Further, the top opening faces away from a substrate on which the inductive component may be mounted using the header component. Thus, the top opening does not compromise the insulation of the inductive component with respect to the substrate and other devices mounted adjacent to the inductive component on that substrate. The header component may advantageously improve the shielding of the inductive component with respect to the substrate and/or other components. In particular, it is not necessary to provide an opening to a lateral side which may compromise insulation and/or shielding to that side.

In general, the terms “bottom”, “bottom side”, “top”, “top side”, “lateral side” or the like are not to be understood restrictive with regard to any direction in space, but are only used to illustrate the relative arrangement of parts of the header component, in particular its housing, as well as an inductive device comprising the header component. In general, “bottom side” indicates the side of the inductive device, which, when the inductive device is mounted on a substrate, faces that substrate, in particular is parallel to that substrate. “Top side” indicates the side of the inductive device or its header component, which faces away from the substrate in the mounted state. “Lateral side” indicates a side, which extends away from the substrate in a mounted configuration, in particular which is perpendicular to that substrate.

The housing of the header component confines the cavity to a bottom side and to at least three lateral sides. The housing may in particular comprise a bottom portion, in particular a bottom plate. The housing may further comprise side walls for confining the cavity to the respective lateral sides. For example, the side walls and the bottom portion may be integrally formed. It is also possible to connect different parts together to form the housing.

The top opening is configured so that the inductive component may be inserted into the cavity. Preferably, the top opening has the same shape and/or dimensions as a respective cross section of the cavity. This ensures that the inductive component can fill up as much space of the cavity as possible. This minimizes unused space inside the housing of the header component. The space needed for housing the inductive component is reduced. This reduces the footprint of the header component on the substrate. For example, the top opening may be framed by top edges of side walls of the housing.

The header component comprises a plurality of terminals for electrically connecting the inductive component to the substrate. In particular, the terminals may be connected to one or more coils of the inductive component. For example, the terminals may be directly connected to leads of the respective coils, in particular to leads formed by the wires winded to form the coils. It is also possible, to provide an electrical connection via intermediate conductors, in particular by intermediate conductors being part of the header component.

The plurality of terminals may be divided into different groups. For example, the terminals may be divided in a group of primary terminals and a group of secondary terminals which connect to primary or secondary circuits of the inductive component, respectively. For example, the inductive component may be a transformer comprising one or more primary coils or windings and one or more secondary coils or windings.

Different terminals, in particular different groups of terminals, may be spaced apart from each other. For example, the terminals may be aligned along opposite lateral sides of the inductor. This is particularly suitable if terminals on one lateral side are connected primary coils and terminals, which are arranged on an opposite lateral side, are connected to secondary coils of the inductor. This way, a physical distance between the terminals may be used to increase the creepage distance of the respective circuits.

The header component has the particular advantage that it allows to maximize insulation and safety distances for the inductive component. In particular, sufficient insulation may be obtained without the need of potting the inductive component. Hence, possibly negative effects of the potting material on the magnetic properties of the inductive device are avoided. Further, the avoidance of potting material eases the compliance with regulations like the directive concerning the restriction of certain hazardous substances (RoHS directives), e.g. the Directive 2011/65/EU of the European Union.

The terminals protrude outwardly from the housing at the bottom side. In particular, the terminals protrude in a direction away from the cavity. For example, the terminals may protrude in a direction perpendicular to and/or parallel to a bottom side of the housing.

The terminals may be configured for surface mounting and/or through-hole mounting the header component onto the substrate. For example, the terminals may comprise mounting sections which may be used for soldering the header component to the substrate. The terminals may alternatively or additionally comprise pins, which may be inserted in respective through-holes of the substrate.

The housing, in particular the side walls, may comprise guiding elements for guiding leads of the inductive component to the respective terminals. Preferably, the guiding elements may be formed as guiding grooves within the housing, in particular within one or more of the side walls. Guiding grooves have the advantage that the leads can be securely routed within the grooves without protruding elements on the outside of the housing which may be damaged during further handling, in particular mounting the header component to a substrate.

A header component according to claim 2 provides a particularly good protection, insulation and/or shielding of the inductive component. After inserting the inductive component into the cavity, the top opening may be at least partially covered by a cover, so that the inductive component is protected inside the cavity from all sides.

A header component according to claim 3 allows for a particularly simple, in particular automation-friendly, and flexible assembly. Particularly preferable, the lateral opening and the top opening may form a common insertion opening. This simplifies the insertion of the inductive component in the cavity. Further, the lateral opening may ease inspection of the placement of the inductive component inside the cavity, in particular of its positioning inside the cavity.

The lateral opening may advantageously be used to route leads of the inductive component out of the cavity to the respective terminals. For example, at least parts of the terminals may be arranged adjacent to the lateral opening. This way, leads of the inductive components may be connected to the respective terminals without requiring routing the leads outside of the cavity along the housing. Particularly preferable, a first group of terminals may be arranged adjacent to the lateral opening and a second group of terminals may be arranged at a lateral side of the housing which is opposite to the lateral opening. This way, different groups of terminals can be securely spaced apart from each other while being easily accessible for connecting leads of the inductive component to the respective terminals. For example, leads, in particular in the form of insulated wires, may be routed out of the cavity through the lateral opening and around the housing to the terminals arranged at the opposite lateral side. Particularly preferable, the leads may be routed in respective guide grooves being incorporated in lateral side walls of the housing which connect the lateral opening to the opposite lateral side.

A header component according to claim 4 provides an easy and stable electrical connection of the inductive component to the at least one terminal comprising the connection section. In particular, it is not required to route one or more leads of the inductive component outside of the housing to the respective terminals. The one or more leads may be directly or indirectly connected to the connection section at the top side. Particularly preferable, the connection section may protrude from a top edge of the respective side wall. This simplifies the electrical connection to the inductive component via the connection section.

It is possible that all terminals comprise respective connection sections extending from the bottom side to the top side, in particular which may protrude from the top edge of a respective side wall. Preferably, a first group of terminals, in particular terminals which are arranged along one lateral side of the housing, comprise respective connection sections. Another group of terminals, in particular terminals which are arranged at a lateral side opposite to the first group of terminals, may not comprise respective connection sections. This way, different groups of terminals may be connected to respective leads of the inductive component in different ways. This may increase the insulation and safety distances between different circuits, in particular between different coils, of the inductive component.

A header component according to claim 5 is particularly robust and secure. Embedding the connection section inside the side wall of the housing leads to a secure and stable anchorage of the respective terminal via the connection section. Particularly preferable, a middle part of the connection section which extends from the bottom side to the top edge of the side wall is completely embedded in the side wall, while an end part of the connection section protrudes over the top edge of the side wall.

It is a further object of the present invention to improve an inductive device for mounting on a substrate, in particular to provide an inductive device which may be easily and economically assembled and fulfills high safety requirements, in particular with respect to insulation and material safety.

This object is achieved by an inductive device with the features of claim 6. The inductive device comprises the inventive header component and an inductive component, in particular a transformer, comprising one or more coils. The inductive component is placed inside the cavity of the housing of the header component. Leads of the one or more coils of the inductive component are electrically connected to respective terminals of the header component. The advantages of the inductive device correspond to that of the header component discussed above.

The inductive component is preferably a transformer. Suitable inductive components, in particular suitable transformers, are known from the prior art. Particularly preferable, the inductive component is a bobbin-wound transformer. Bobbin-wound transformers have a small form factor, reducing the size of the inductive device and with that its footprint on the substrate.

Particularly suitable bobbin-wound transformers may comprise one or more primary coils and one or more secondary coils. Preferably, insulated wire may be used to wind the primary and/or the secondary coils. Particularly preferably, insulated wire may be used to wind the primary coils or the secondary coils, while the respective other one or more coils are wound by non-insulated wire. Using non-insulated wires for the secondary or primary coil reduces the costs without affecting the insulation to the respective other coils which are wound from insulated wire.

Particularly preferable, terminals which are connected to leads of primary coils are arranged at a different lateral side than terminals which are connected to leads of secondary coils. The creepage distance between terminals of different coils is increased.

An inductive device according to claim 7 is particularly stable and suitable for automated assembly. The contacts protruding from the top opening simplify the electrical connection to the respective terminals. Further parts of the inductive device, e.g. a cover, may be electrically and/or mechanically connected to the inductive component via the contacts. In particular, it is not necessary to route the respective leads out of the cavity reducing the risk of damaging the leads while operation.

An inductive device according to claim 8 securely protects the inductive component and may be assembled in a particularly automation-friendly way. The cover at least partially, preferably completely, covers the top opening to a top side. The top opening does not compromise the further handling of the inductive device, in particular the mounting of the inductive device on a substrate. An upper surface of the cover may in particular serve as a holding point for grip-and-place techniques for handling the inductive device, e.g. by mechanical or pneumatic grippers.

The cover may be attached to the housing of the header component and/or to the inductive component. Attaching the cover to the housing and to the inductive component has the advantage of providing a mechanical fixation of the inductive component. In particular, the inductive component is not only mechanically connected to the header component via the electrical connections of the coils to the respective terminals. This reduces the risk of damaging the electrical connection during further handling and/or usage.

The housing may comprise one or more fixation elements for fixing to the housing to the. For example, one or more anchoring protrusions may protrude from a top edge of one or more side walls for being connected to the cover. For example, an anchoring protrusion may be inserted in a respective through-hole of the cover.

Particularly preferable, the housing confines the cavity to all four lateral sides. The additional cover also covers the inductive component from the top side so that the inductive component is securely housed within the cavity.

An inductive device according to claim 9 is particularly stable and can be easily handled, e.g. while mounting on a substrate. Particularly preferable, the cover may be connected to the inductive component prior to placing it inside the cavity. Thus, the cover may simplify the handling of the inductive component, e.g. providing a gripping surface for grip-and-place techniques. Preferably, the cover is attached to the inductive component via respective contacts of the conductive component. The attachment can in particular be achieved by surface mounting technique (SMT) and/or through-hole technique (THT). The cover may also be used for establishing an electric connection to the respective terminals.

An inductive device according to claim 10 provides a secure electrical connection, which may in particular be automation-friendly assembled. The conductor patterns may be formed on the cover, in particular on a surface of the cover which faces the housing. It is also possible to form the conductor patterns inside the cover to securely protect them from the environment. For example, the conductor patterns may be in contact with contacts of the inductive components protruding from the top opening, e.g. by surface mounting or through-hole mounting. The electrical connection using the conductor patterns does not require to route the leads of the respective at least one coil out of the cavity, increasing the stability and safety of the inductive device.

The inductive component may comprise further contacts, which are not electrically connected to leads of one of the coils. These contacts may be used for connecting to the cover, in particular to a circuit board. This way, the mechanical attachment of the cover to the inductive component may be improved. For example, insulated contacts may be attached to insulated contact pads of the cover.

An inductive device according to claim 11 is particularly stable as well as easy and efficient to manufacture. The connection of the contacts of the inductive device with the connection sections of the respective terminal via the conductor patterns further increases the stability of the electrical connection. It is in particular not required to provide additional connection components which may compromise the stability of the electrical connection. Further, the connection via the conductor patterns of the cover may increase the mechanical stability of the inductive device. For example, protruding connection sections of the respective terminals may be attached to the cover, e.g. by being inserted in respective through-holes of the cover. This way, a mechanical connection between the header component and the inductive component is established via the cover.

Particularly preferable, one group of terminals is connected to the respective leads via conductor patterns in the cover. Another group of terminals may be connected to the respective leads by routing the leads out of the cavity and the around the housing to the respective terminals. Via different connection techniques, the insulation of the respective coils of the inductive component may be increased. In this regard, it is particularly advantageous if the leads which exit the cavity, in particular via the top opening, are formed of insulated wire. This increases the insulation. In particular, any contact with conductor patterns on the cover is reliably avoided.

A cover according to claim 12 is particularly suitable for an easy and efficient connection to the inductive component and/or the header component. In particular, a circuit board may be attached to contacts of the inductive component and/or parts of the header component, e.g. connection sections of terminals and/or anchoring protrusions, via surface mounting techniques or through-hole techniques.

The cover may in particular be a printed circuit board. The cover in form of a circuit board is not to be confused with the substrate, in particular circuit board, on which the inductive device may be mounted via the terminals.

An inductive device according to claim 13 can be easily handled, in particular mounted on a substrate. The cover may in particular be suitable for tool-less removal. A cover which is removable may also be referred to as cap. A removable cap may be used for protecting the inductive component during the further handling, in particular during mounting of the inductive device on a substrate. The removable cover or cap may, e.g., provide a griping surface for pick-and-place techniques, in particular for mechanical or pneumatic grippers. After mounting the inductive device on the substrate, the cap may easily be removed. After mounting the inductive device, the cover is no longer used for handling the inductive device. Further, covering the top opening may not be needed in the final product. Thus, a removable cover has the advantage that it does not have to fulfill all safety requirements and/or regulations required for the final product. The cap may be used in the manufacturing process without impacting the bill of materials (BOM) of the final product.

It is a further object of the present invention to improve a method for assembling an inductive device, in particular to provide a method which is efficient and economical.

This problem is solved by the method of claim 14. The inventive header component is provided. An inductive component, in particular a transformer, comprising one or more coils is provided. The inductive component is placed inside the cavity of the housing of the header component at least partially via the top opening, in particular solely via the top opening. The leads of one or more coils of the inductive component are electrically connected to the respective terminals of the header component. The method advantageously allows to use pick-and-place techniques, in particular automated pick-and-place techniques, to vertically insert the header inside the housing via the top opening. This allows for a simple and efficient assembly of the inductive device. Production costs and scrap rates due to a wrong insertion of the inductive component are reduced.

The provided inductive component may preferably be a transformer, in particular a bobbin-wound transformer. Providing the inductive component may comprise manufacturing the inductive component, in particular the bobbin-wound transformer. Provision of the inductive component may in particular comprise winding one or more coils on a mount, in particular a bobbin mount. For example, one or more coils of the inductive component may be automatically wound, e.g. by a multi arbour automated winding machine.

Particularly preferable, the provision of the inductive component may comprise winding one or more coils from insulated wire and one or more coils from non-insulated wire. In particular, insulated wires may be left as flying leads. Additionally or alternatively, some of the wires, in particular non-insulated wires, may be terminated on respective contacts of the inductive component. In particular, it is possible to autoterminate the wires on the respective contacts.

A method according to claim 15 leads to reduced material costs. Directly connecting the leads of at least one of the coils to the respective terminals does not require intermediate components for establishing the connection. For example, the respective leads, in particular leads made of insulated wire, may be routed out of an opening of the housing, in particular the top opening and/or a lateral opening, to be connected to the respective terminals. When providing the inductive component, leads, which are to directly connect to the respective terminals, may be left as flying leads. This simplifies the provision of the inductive component.

A method according to claim 16 is particularly efficient. The termination of leads of at least one coil of the inductive component on respective contacts can be preferably established upon the manufacture of the inductive component, e.g. by autoterminating the respective wires when winding the respective at least one coil. This way, it is not necessary to, in particular manually, route the respective leads out of the cavity to connect the leads to the respective terminals.

A method according to claim 17 is particularly automation-friendly. The connection of the leads of at least one coil to conductor patterns of the cover may be achieved by known mounting techniques. Particularly preferable, the cover may comprise a circuit board which simplifies the electrical connection to the leads. Particularly preferable, the connection may be established via contacts of the inductive components at which the leads of the at least one coil are terminated.

Particularly preferable, the cover, in particular the circuit board, is attached to the inductive component prior to insertion of the inductive component inside the cavity. The cover may be used as a gripping surface for pick-and-place techniques when inserting the inductive component inside the cavity.

A method according to claim 18 is particularly efficient. Preferably, the connection sections of the respective terminals protrude from a top edge of the housing. The connection sections may automatically connect to the conductor patterns of a cover, in particular upon placing the inductive component inside the cavity thereby also placing the cover above the top opening. For example, the connection sections penetrate respective through-holes of the cover, in particular of a circuit board of the cover.

A method according to claim 19 is particularly cost-efficient. The cover may be used to protect the inductive component during handling, in particular during mounting the inductive device on a substrate device. After that, the cover may be removed to not further influence the properties of the inductive device and the final product.

Further details, advantages and features of the invention emerge from the description of illustrative embodiments with reference to the figures.

### BRIEF DESCRIPTION OF THE DRAWINGS

FIG. 1 shows a perspective side view of an exemplary embodiment of an inductive device comprising an inductive component in form of a transformer and a header component,

FIG. 2 shows a longitudinal section through the inductive device along a section line II-II in FIG. 1,

FIGS. 3 to 6 schematically illustrate different steps of the assembly of the inductive device according to FIG. 1,

FIG. 7 shows a perspective front view of a further exemplary embodiment of an inductive device, and

FIG. 8 shows a perspective rear view of the inductive device according to FIG. 7.

### DETAILED DESCRIPTION

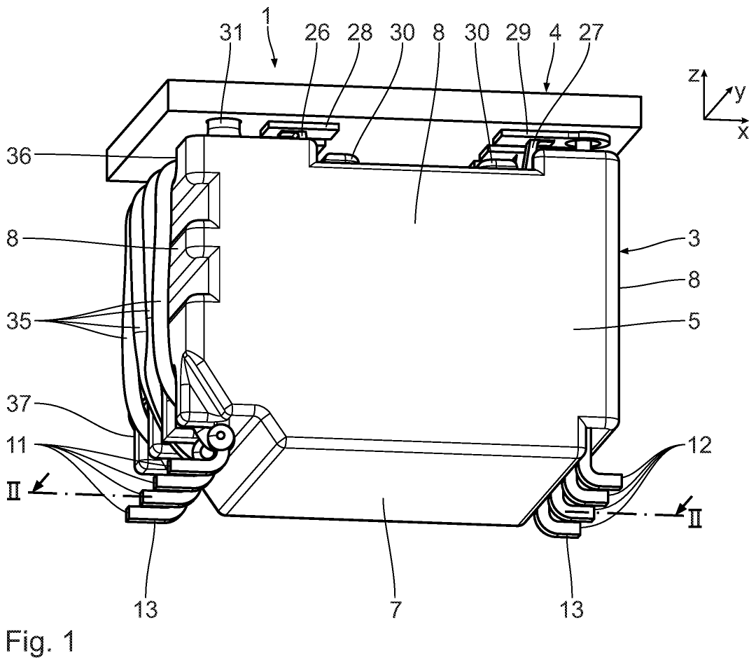

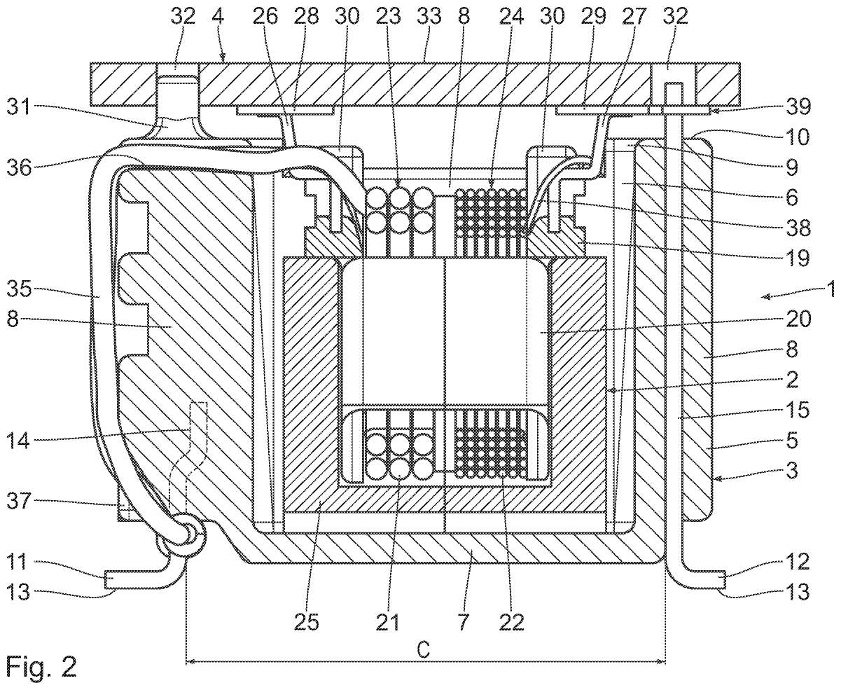

With reference to FIGS. 1 and 2, a first exemplary embodiment of an inductive device 1 is described. The inductive device 1 comprises an inductive component 2 and a header component 3 for mounting the inductive component 2 on a substrate (not shown). The inductive device 1 further comprises a cover 4.

The header component 3 comprises a housing 5 which houses the inductive component 2. The housing 5 defines a cavity 6, in which the inductive component 2 is placed. The housing 5 comprises a bottom portion 7 confining the cavity 6 to a bottom side and side walls 8 confining the cavity to all four lateral sides. The housing 5 comprises a top opening 9 to the cavity 6. The top opening 9 is arranged at a top side of the housing 5 which is opposite to the bottom portion 7. The top opening 9 is configured in size and shape so that the inductive component 2 can be inserted into the cavity via the top opening 9. In the shown embodiment, the top opening 9 has a dimension corresponding to the cross-section of the cavity 6 which is parallel to the bottom side of the housing 5. Thus, the top opening 9 is framed by upper edges 10 of the side walls 8 of the housing 5.

In general, the terms “bottom”, “bottom side”, “top”, “top side”, “lateral side” or the like are not to be understood restrictive with regard to any direction in space, but are only used to illustrate the relative arrangement of parts of the inductive device 1, in particular of the header component 3 and its housing 5. For illustrative purposes only, Cartesian coordinates x, y, z are indicated in FIG. 1. In FIG. 1, the bottom side of the housing 5, in particular its bottom portion 7, is arranged perpendicular to the z-axis. The lateral sides of the housing 5, in particular its side walls 8, extend along the z-axis. The top side of the housing 5, in particular the top opening 9, is perpendicular to the z-axis. The substrate to which the inductive device 1 may be mounted may be arranged in the x-y-plain, so that the substrate and the bottom portion 7 are parallel to each other.

The header component 3 comprises a plurality of terminals 11, 12. The terminals 11, 12 comprise a group of primary terminals 11 and a group of secondary terminals 12. In the shown embodiment, the header component 3 comprises four primary terminals 11 and four secondary terminals 12. The primary terminals 11 are arranged along one of the side walls. The secondary terminals 12 are arranged along one of the side walls 8, which is opposite to the side wall along which the primary terminals 11 are arranged.

The terminals 11, 12 serve for electrically connecting the inductive component 2 to the substrate and for fixing the inductive device 1 to the substrate 1. The terminals 11, 12 protrude from the bottom side of the housing 5 in direction perpendicular to the bottom portion 7. The terminals 11, 12 each comprise a mounting section 13. The mounting section 13 is formed by an extension of the terminals 11, 12 which is bent to extend in lateral direction. The mounting sections 13 serve as a fixation area, in particular as soldering area, via which the terminals 11, 12 may be fixed, in particular soldered, to the substrate. Fixing the terminals 11, 12 to the substrate establishes an electrical connection between the substrate and the inductive component 2. The inductive device 1 is particularly suitable for being mounted using surface mounting technology (SMT). In other, non-shown embodiments, the mounting sections may extend in direction perpendicular to the bottom portion 7, e.g. in form of connection pins. Such embodiments may be particularly suitable for mounting the inductive device 1 to the substrate by through-hole technology (THT).

The primary terminals 11 comprise an anchoring section 14, which is anchored in one of the side walls 8 of the housing 5. The primary terminals 11 are fixed to the housing 5 via the anchoring sections 14.

The secondary terminals 12 each comprise a connection section 15 which is embedded in the respective side wall 8 of the housing 5. The connection section 15 extends from the bottom side, where the mounting section 13 is formed through the side wall 8 to the top edge 10 of the respective side wall 8. The connection section 15 protrudes from the top edge 10 of the side wall 8 at the top side.

In the shown embodiment, the inductive component 2 is a transformer, specifically a bobbin-wound transformer. The inductive component 2 comprises a transformer core 20. The transformer core 20 is inserted in a bobbin mount 19, around which primary wires 21 and secondary wires 22 are wound to form primary coils 23 and secondary coils 24, respectively. Transformer core 20, the bobbin mount 19 and the coils 23, 24 are at least partially encased in an encasement 25. The transformer 20, the coils 23, 24 and the encasement 25 may be implemented in a known manner and are not shown in detail in the figures. For example, the encasement 25 may be formed by potting the coils in a potting material. In other embodiments, the encasement 25 does not require potting material. This is advantages, as it eases the requirements with respect to material compliance regulations. For example, the encasement may be formed by a transformer housing, in which the transformer core is placed. In particularly advantageous embodiments, the encasement 25 may be provided by gluing the transformer core with adhesive. In yet other embodiments, the transformer does not comprise an encasement.

In the shown embodiment, the primary wires 21 are insulated wires. The secondary wires 22 are non-insulated wires.

The inductive component 2 comprises primary contacts 26 and secondary contacts 27. The inductive component 2 is placed inside the cavity 6 so that the contacts 26, 27 protrude from the top opening 9. The inductive component 2 is positioned inside the cavity 6 so that the primary contacts 26 are arranged at a lateral side neighboring the side wall 8, along which the primary terminals 11 are arranged. The secondary terminals 27 neighbor the side wall 8 along which the secondary terminals 12 are arranged.

Protruding ends of the primary contacts 26 are soldered to respective primary contact pads 28 of the cover 4. Protruding parts of the secondary contacts 27 are soldered to respective secondary contact pads 29 of the cover 4. Thereby, the cover 4 is fixed to the inductive component 2. In the shown embodiment, the fixation is done by surface mount technology. In other embodiments, the contacts of the inductive component 2 may be connected to the cover 4 by through-hole technology.

The contacts 26, 27 are anchored within flanges 30 of bobbin mount 19. The primary contacts 26 and the primary contact pads 28 are electrically isolated from the coils 23, 24 of the inductive component 2 and the terminals 11, 12 of the header component 3. Thus, the primary contacts 26 and the primary contact pads 28 do not contribute to an electrical connection of the coils 23, 24 to the terminals 11, 12.

The secondary contacts 27 and the secondary contact pads 29 contribute to electrically connecting the secondary coils 24 to the secondary terminals 12 as will be described later.

The housing 5 of the header component 3 comprises an anchoring protrusion 31 which protrudes from the upper edge 10 of at least one of the side walls 8. In the shown embodiment, the anchoring protrusion 31 is arranged at the upper edge 10 of the side wall 8, which is opposite to the side wall 8 in which the connections sections 15 of the secondary terminals 12 are embedded. The anchoring protrusion 31 and the end of the connection section 15, which protrude from the upper edge 10, reach into respective through-holes 32 in the cover 4, thereby mechanically connecting the cover 4 to the header component 3.

In the assembled inductive device 1, the cover 4 covers the top opening 9 of the housing 5 from the top. The cover 4 protects the inductive component 2. Further, an upper surface 33 of the cover 4 provides a gripping surface, at which the inductive device 1 can be gripped for further manufacturing steps, e.g. for placing the inductive device 1 on the substrate. In particular, the upper surface 33 can serve as a gripping surface for mechanical or pneumatic grippers, thereby allowing for an easy and efficient handling, in particular automatic handling, of the inductive device 1.

In the following, the electric connection between the coils 23, 24 and the respective terminals 11, 12 is described. When winding the primary coils 23, ends of the insulated wire 21 are left as flying leads 35. The flying leads 35 are led out of the cavity 6 around the upper edge 10 of the side wall 8, along which the primary terminals 11 are arranged. The leads 35 are routed along the outside of the side wall 8 to the respective primary terminals 11 and connected thereto. Via the leads 35, the coils 23 are directly connected to the respective terminals 11 in an easy and simple manner.

For routing the leads 35, guiding elements may be provided on the respective side wall 8 of the housing 5. In the shown embodiment, a guiding groove 36 is formed at the top edge 10 of the side wall 8. The leads 35 exit the cavity 6 through the guiding groove 36. At a bottom edge of the side wall 8, guiding protrusions 37 are formed between which the leads 35 are routed to the respective primary terminal 11.

The secondary coils 34 are wound from non-insulated wires 22. Leads 38 of the non-insulated wires 22 are terminated on the respective secondary contacts 27. Thus, there is an electrical connection between the secondary coils 24 and the secondary contacts 27. Since the secondary contacts 27 are connected to respective secondary contact pads 29, the secondary coils 24 are electrically connected to the cover 4. The secondary contacts pads 29 are part of respective conductor patterns 39 which connect the secondary contacts 27 to the contact sections 15 of the respective secondary terminals 12. Thus, the secondary coils 24 are connected to the respective secondary terminals 12 via the secondary contacts and the respective conductor patterns 39, the latter being comprised by the cover 4. This allows for an easy and reliable electrical connection which is established simply by connecting the cover 4 to the inductive component 2 and the header component 3.

In general, the cover may provide connection elements for mechanically and electronically connecting to the inductive component 2 and the header component 3. In the shown embodiment, these are the through-holes 32 and the contact pads 28 and the conductor patterns 39 comprising the contact pads 29. Advantageously, the cover 4 is a circuit board. Using a circuit board as cover 4 allows for an easy and reliable mechanical as well as electrical connection, using surface mount technology and/or through-hole technology.

The electrical connection of the coils 23, 24 to the respective terminals 11, 12 maximizes the creepage and clearing distances for inductive device 1. The primary terminals 11 and the secondary terminals 12 are arranged along two opposite side walls of the housing 5 of the header component. Thus, the creepage distance corresponds to a physical distance of the primary terminals 11 to the secondary terminals 12, as indicated in FIG. 2. Thus, the inductive device 1 combines the advantages of a compact design with an increased creepage distance.

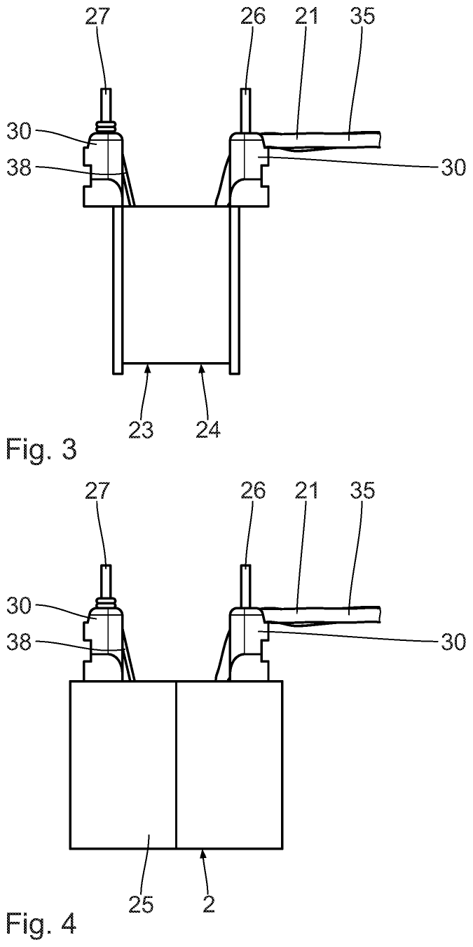

With regard to FIGS. 3 to 6, a method for assembling an inductive device is described. The method is particularly suitable for assembling the inductive device 1 shown in FIGS. 1 and 2. Further, the method is suitable for assembling different variations of an inductive device. For simplicity, the components of the to be assembled inductive device are only schematically shown in FIGS. 3 to 6 and are indicated with the same reference numbers as for the inductive device 1 in FIGS. 1 and 2.

As shown in FIG. 3, the coils 24, 23 are wound on the bobbin mount 19. The contacts 26, 27 protrude from flanges 30 of the bobbin mount 19. The ends of the insulated wires 21 are left as flying leads 35. The leads 38 of the non-insulated wires are terminated on the secondary contact 27.

Winding the coils 23, 24 may be performed automatically. For example, a multi arbour automated winding machine may be used. Particularly preferable, the leads 38 of the non-insulated wire are autoterminated on the respective secondary contacts.

After winding the coils 23, 24, the inductive component 2 is assembled, in particular by introducing the transformer core 20 into the bobbin mount 19 and by encasing the coils 23, 24 at least partially in the encasing 25. The assembled inductive component 2 is shown in FIG. 4.

As shown in FIG. 5, the inductive component 2 is connected to the cover 4 via the contacts 26, 27, for example by soldering the contacts 26, 27 to the cover, in particular to respective contact pads. The cover 4 is a circuit board. Connection between the contacts 26, 27 may preferably be established via through-hole technology or surface mount technology. In the shown embodiment, primary contacts 26 are insulated from the primary coils 23. Thus, primary contacts 26 establish a mechanical connection to the cover 4. Secondary contacts 27 are electrically connected to the secondary coils 24. Thus, secondary contacts 27 establish a mechanical connection as well as an electrical connection to the cover 4, in particular to conductor patterns 39.

Connecting the cover 4 to the inductive component 2 prior to inserting the inductive component 2 in the cavity 6 of the header component 3 has the advantage that the upper surface 33 of the cover 4 may be used as gripping surface also for placing the inductive component 2 inside the cavity 6 via the top opening 9.

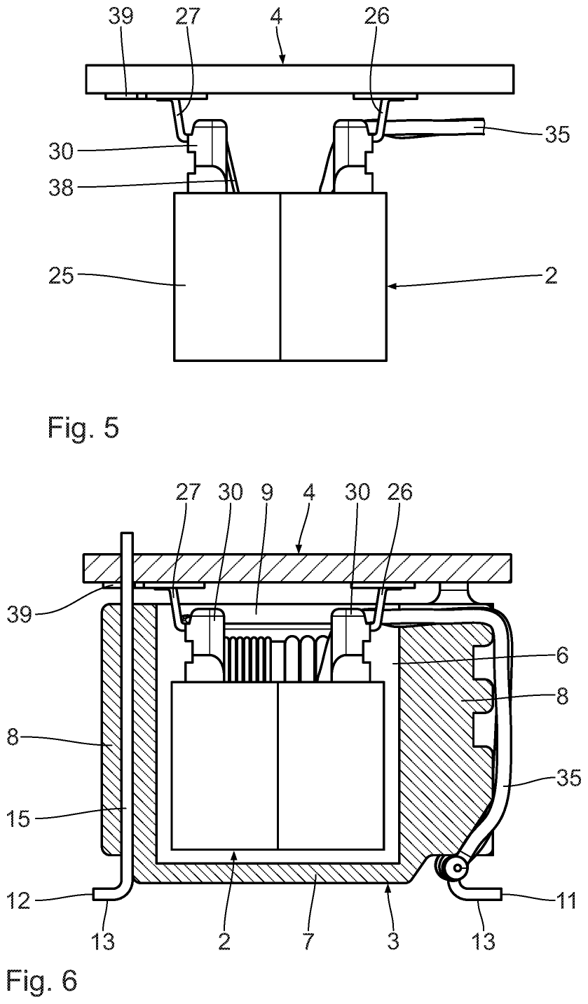

As shown in FIG. 6, the inductive component 2 is placed inside the cavity 6 of the header component 3. The inductive component 2 is placed inside the cavity through the top opening 9. This allows an automation-friendly and easy placement of the inductive component 2 inside the header component 3 from the top.

The inductive component 2 is placed inside the cavity 6 so that the contacts 26, 27 protrude from the top opening 9.

Placing the inductive component 2 inside the cavity 6 also positions the cover 4 relatively to the header component 3. The cover 4 covers the top opening 9. The cover 4 is connected to connection sections 15 of the secondary terminals 2 as to establish an electrical connection from the secondary coils 24 to the secondary terminals 12. Leads 35 are routed around the side wall 8 and connected to the respective primary terminals 11. Routing and connection of leads 35 may, for example, be done manually.

In the shown embodiment, the primary coils are connected to the respective terminals via insulated wires routed around the housing. The secondary coils are connected to the respective terminals via conductor patterns in the cover and connection sections of the terminals extending to the cover. Many other variations of inductive devices are possible. For example, it is possible to wind primary and secondary coils from insulated wires and to route the respective wires each around the respective side walls and connected directly to the respective terminals. This way, material costs and part complexity may be reduced. In some embodiments, a cover for covering the top opening is not needed. Further, the inductive component does not need to provide respective contacts.

In yet other embodiments, the wires of the primary and secondary coils may be terminated on respective contacts. Connection to the terminals of the header component may in each case be established via respective conductor patterns in the cover and connection sections of the terminals. Such a type of connection is particularly suitable for automated assembly of the inductive device.

In yet other embodiments, different connections to the cover may be used. For example, the cover may be mechanically connected to the header component and/or the inductive component. For establishing an electrical connection to the conductor pattern of the cover, respective contacts on which the wires are terminated are not necessary. It is possible to connect leads of the respective coils directly to conductor patterns of the cover.

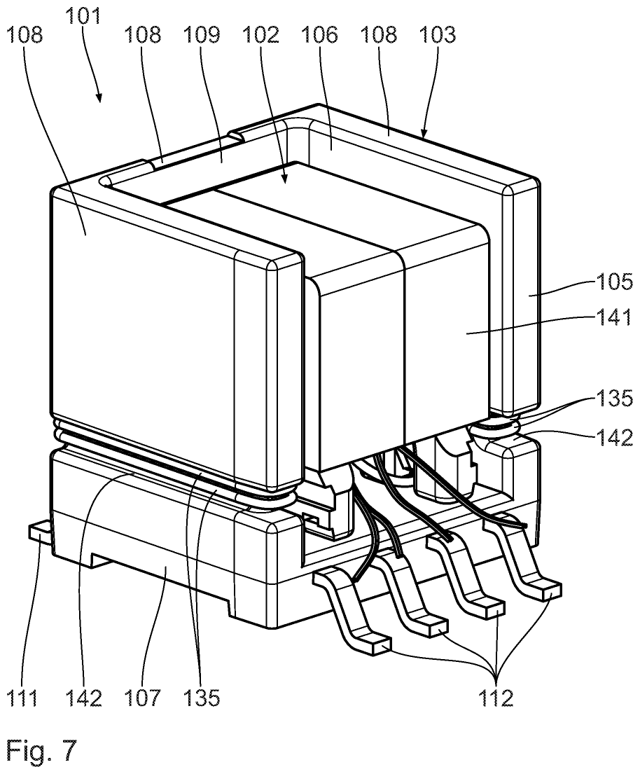

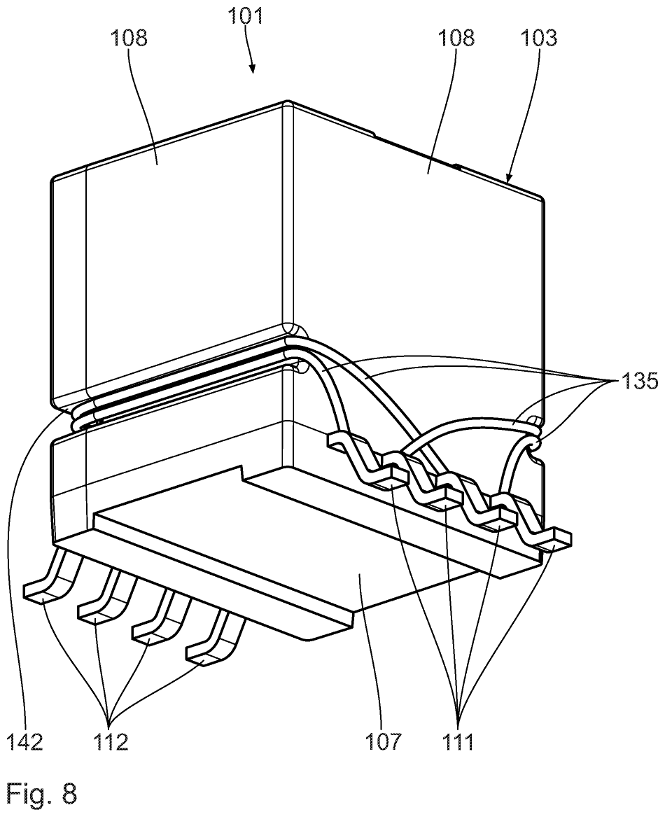

With regard to FIGS. 7 and 8, a further embodiment of an inductive device 101 is described. The inductive device 101 comprises an inductive component 102. Inductive component 102 is a bobbin-wound transformer comprising primary and secondary coils (not shown).

Inductive component 102 is placed in a cavity 106 of a header component 103. Cavity 106 is confined by a housing 105 of header component 103. The housing 105 comprises a bottom portion 107 and side walls 108 confining the cavity 106 to the three lateral sides and to the bottom side. Opposite to the bottom portion 107, the housing 105 comprises a top opening 109, through which the inductive component 102 can be inserted into the cavity 106. On one lateral side, the housing 105 comprises a lateral opening 141. The top opening 109 and the lateral opening 141 form a common insertion opening. The common insertion opening simplifies the insertion of the inductive component 102. Further, a visual inspection of the correct placement of the inductive component 102 inside the cavity 106 is simplified, in particular during the actual placing procedure.

The header component 103 comprises primary terminals 111 and secondary terminals 112. Primary terminals 111 connect to primary coils of the inductive component 102. Secondary components 112 connect to secondary coils of the inductive component 102. In the shown embodiment, the header component 103 comprises four primary terminals 111 and four secondary terminals 112.

The terminals 111, 112 protrude from the bottom side of the housing 105. The terminals 111, 112 protrude laterally from the bottom portion 107. The secondary terminals 112 are arranged adjacent to the lateral opening 141. The primary terminals 111 are arranged at a side wall 108 which lays opposite to the lateral opening 141.

Leads 138 of the secondary coils are routed through the lateral opening 141 and are directly connected to the neighboring secondary terminals 112. Secondary coils as well as leads 138 are formed from non-insulated wires.

Leads 135 of the primary coils exit the cavity 106 via the lateral opening 141 and are routed to the opposite side wall 108 to connect to the respective terminals 111. The side walls 108 neighboring the lateral opening 141 comprise guide grooves 142, in which the leads 135 are guided to the side of the housing 105 opposite to the lateral opening 141. The leads 135 are securely held inside the guide grooves 142.

The inductive device 101, in particular its header component 103, has a simple construction. At the same time, a safe separation of primary and secondary circuits of the inductive component 102 is established, benefitting from a large creepage distance.

The inductive device 101 can be easily assembled, in particular using automated placing techniques for placing the inductive component 102 inside the cavity 106. The inductive component 102 can be provided, in particular manufactured with known techniques. The provided inductive component 102 is inserted in the cavity 106 at least partially via the top opening 109. The leads 138 are connected to the secondary terminals 112 adjacent to the lateral opening 141. The leads 135 are routed out of the lateral opening 141 and around the adjacent side walls to the respective primary terminals 111 and connected thereto.

In some embodiments, a cover can be placed on the housing 105 of the header component 103 to cover the top opening 109 after the inductive component 102 has been placed inside the cavity 106. This way, the top opening 109 is at least temporarily covered to protect the inductive component 102 inside the cavity 106. The cover may also serve as a gripping surface for further handling and production steps, e.g. for placing the inductive device 101 on a substrate. In particularly advantageous embodiments, the cover is attached to the housing 105 in a removable manner. The cover may only be temporarily placed on the housing 105. In particular, the cover may be removed after mounting the inductive device 101 on a substrate. Using a removable cover has the advantage that the cover does not have to be considered in the final product's bill of materials (BOM). Another advantage is that there are less restrictions on the choice of material for the cover. For example, materials may be used which do not meet certain requirements and regulations for the final product.

In further exemplary embodiments, the leads 135 may be routed around the top edge of the side wall opposite to the lateral opening 141. This way, it is not necessary to route the leads 135 along the side walls neighboring the lateral opening 141.

In further exemplary embodiments, the housing may comprise four side walls to confine the cavity to all four sides. The inductive component may then be placed inside the cavity via the top opening. The leads of the inductive component may be routed around top edges of the side walls to the respective terminals.

1. Header component for mounting an inductive component, in particular a transformer, on a substrate, the header component comprising
a housing for housing the inductive component inside a cavity,
wherein the housing confines the cavity to a bottom side and to at least three lateral sides, and
wherein the housing comprises a top opening to the cavity at a top side opposite to the bottom side, wherein the top opening is configured so that the inductive component can be inserted into the cavity via the top opening, and
a plurality of terminals for electrically connecting the inductive component to the substrate, wherein the terminals outwardly protrude from the housing at the bottom side.

2. Header component according to claim 1, wherein the housing confines the cavity to all four lateral sides.

3. Header component according to claim 1, wherein the housing comprises a lateral opening to the cavity at one of the lateral sides.

4. Header component according to claim 1, wherein at least one of the plurality of terminals comprises a connection section extending from the bottom side to the top side of the housing, in particular to a top edge of a side wall of the housing which is adjacent to the top opening.

5. Header component according to claim 4, wherein the connection section is embedded in at least one side wall of the housing.

6. Inductive device for being mounted on a substrate, comprising
a header component as claimed in any one of the preceding claims and
an inductive component, in particular a transformer, comprising one or more coils,
wherein the inductive component is placed inside the cavity of the housing of the header component, and
wherein leads of the one or more coils of the inductive component are electrically connected to respective terminals of the header component.

7. Inductive device according to claim 6, wherein the inductive component comprises contacts, via which leads of at least one coil of the inductive component are connected to the respective terminals, and wherein the inductive component is arranged inside the cavity so that the contacts protrude from the top opening.

8. Inductive device according to claim 6, comprising a cover at least partially covering the top opening.

9. Inductive device according to claim 8, wherein the cover is attached to the inductive component, in particular to contacts of the inductive component.

10. Inductive device according to claim 8, wherein the leads of at least one coil of the inductive component are connected to the respective terminals of the header component via conductor patterns comprised by the cover.

11. Inductive device according to claim 10, wherein the conductor patterns comprised by the cover connect the respective leads of the inductive component with connection sections of respective terminals of the header component.

12. Inductive device according to claim 8, wherein the cover comprises a circuit board, in particular consists of a circuit board.

13. Inductive device according to claim 8, wherein the cover is removable.

14. Method for assembling an inductive device with the steps,
providing a header component according to claim 1,
providing an inductive component, in particular a transformer, comprising one or more coils,
placing the inductive component inside the cavity of the housing of the header component at least partially via the top opening, and
electrically connecting leads of the one or more coils of the inductive component to respective terminals of the header component.

15. Method according to claim 14, wherein the leads of at least one coil of the inductive component are directly connected to the respective terminals.

16. Method according to claim 14, wherein the leads of at least one coil of the inductive component are terminated on respective contacts of the inductive component and the inductive component is placed inside the cavity so that the contacts protrude from the top opening.

17. Method according to claim 14, wherein a cover is attached to the inductive component so that the leads of at least one coil are connected to conductor patterns comprised by the cover.

18. Method according to claim 17, wherein the conductor patterns comprised by the cover are connected to connection sections of respective terminals of the header component.

19. Method according to claim 14, wherein a cover is removeably attached to the header component and/or the inductive component for at least partially covering the top opening.
